(19) United States
(12) Patent Application Publication
(10) Pub. No.: US 2008/0271000 A1
(43) Pub. Date: Oct. 30, 2008

(54) Predicting Conflicts in a Pervasive System

(75) Inventor: Andreas Heil, Karlsruhe (DE)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/739,953

(22) Filed: Apr. 25, 2007

(51) Int. Cl. G06F 9/45

(52) U.S. Cl. 717/141

(57) ABSTRACT

A method of predicting conflicts in a system is described which uses a process calculus to describe programs and actions within the system. The source code for programs is transformed into an expression in the process calculus and then the reduction rules for the process calculus can be applied to the expressions for the various programs and actions. Analysis of the resultant reduced expression(s) enables potential conflicts to be identified.

### BACKGROUND

As processors and computational abilities are included within more objects, the possibility of conflicts and interferences between programs increases. For example, two programs may access a particular resource or a service providing access to that resource, resulting in a potential conflict if those two programs are both run at the same time, e.g. if the resource is a light, running both programs may cause the light to oscillate as one program switches the light on and the other switches the light off. If the two programs are developed in isolation there is no notification between programs as there might be in different applications which run on the same operating system or within a more controlled environment, and this makes the ubiquitous computing environment (also referred to as a ‘pervasive system’) highly error prone.

Currently, these conflicts can be determined either by observation at run-time, by which time the problem has already occurred, or by checking and comparing all the source code (e.g. before or at compile time). In order to be able to check and compare all the source code, all the source code must be accessible and where programs are developed by different corporations, this is unlikely to be the case because source code is often a closely guarded trade secret. Additionally, if additional elements are added to a pervasive system subsequently, as is extremely likely, all the source code will need to be further examined with reference to the additional element to determine whether any conflicts may be caused by its introduction. Even if all the source code was available for analysis when the pervasive system was originally established, dependent upon the elapsed time, the source code for the original elements in the pervasive system may not be available at the time an additional element is added.

Even if all the source code is available at the time the analysis is to be performed, the checking and comparing process is very time consuming and complex. Not only must it consider whether the programs interfere when devices are in a particular arrangement, but where devices are mobile (e.g. laptops, PDAs, mobile telephones etc), it must also take into consideration the movement of devices as this may result in new conflicts being predicted (e.g. if laptop A and laptop B are moved into the same room, there will be a conflict if they both try to control the projector in that room).

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A method of predicting conflicts in a system is described which uses a process calculus to describe programs and actions within the system. The source code for programs is transformed into an expression in the process calculus and then the reduction rules for the process calculus can be applied to the expressions for the various programs and actions. Analysis of the resultant reduced expression(s) enables potential conflicts to be identified.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is an example flow diagram of a method of predicting conflicts in a distributed system;

FIG. 2 is a building plan;

FIG. 3 shows two representations of the ambient calculus expression for part of the building plan shown in FIG. 2;

FIG. 4 shows a representation of office space and two documents;

FIGS. 5 and 6 show four possible resultant situations in the scheme of FIG. 4;

FIG. 7 is a second example flow diagram of a method of predicting conflicts in a distributed system;

FIG. 8 is an example flow diagram of a method of determining the origin of conflicts in a running distributed system; and

FIG. 9 illustrates an exemplary computing-based device in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Process calculi have been developed for modeling concurrent systems and one example of a process calculus is the Mobile Ambient Calculus developed by Luca Cardelli and Andrew Gordon and described in their paper entitled ‘Mobile Ambients’ published in Foundations of Software Science and Computational Structures (1378: p. 140-155) in 1998. Mobile Ambient Calculus describes the movement of processes and devices, including movement through administrative domains. The fundamental element of this calculus is an ambient, which is a bounded place where computation happens, such as a web page (bounded by a file) or a laptop computer (bounded by its case and data ports). Agents are used to control the movement of ambients and agents are confined to ambients. Agents are able to react to their environment in order to fulfill a particular task, i.e. they have a degree of autonomy. Agents may be distributed (e.g. loosely coupled agents running on independent processors) and may be mobile (i.e. they can move from one system to another based on their own decision). In some embodiments, the agents may be ambients, although this is not required in many embodiments. In a simple example of the operation and mobility of an agent, an agent may be confined to a word document, where the word document is an ambient (bounded by the file). If a person leaves their office, the agent determines that they are leaving the room and causes the word file (and the agent itself) to be copied to the person's smartphone. When they enter another office and sit at another computer, the agent determines this and causes the word file (i.e. the ambient) be copied to the new computer.

An ambient is written n[P] where n is the name of the ambient and P is the process running inside the ambient. Ambients can be arranged hierarchically such that ambients are nested within other ambients, e.g. n[m[P]]. Parallel executed processes are written P|Q and simultaneous existing ambients are composed in the same way, e.g. n[P]|m[Q]. Operations that change the hierarchical structure of ambients are controlled by capabilities and there are three basic kinds of capabilities: one for entering an ambient (‘in n’), one for exiting an ambient (‘out n’) and one for opening up an ambient (‘open n’). The capabilities are obtained from names, n, such that ‘out n’ allows exit out of ambient n, ‘in n’ allows entry into n and ‘open n’ allows the opening of ambient n. These movements for entering and exiting an ambient (‘in n’ and ‘out n’) are referred to as ‘subjective moves’ because they cause the ambient itself to move (e.g. “I move” from the inside). There are corresponding ‘objective moves’ where the command to move comes from outside the ambient (e.g. “I make you move” from the outside) and these are indicated by an ‘mv’ prefix (e.g. mv in n, mv out n). In a simple example where a person carries a laptop from one room to another, the movement of the person can be expressed using subjective notation (because the person moved of their own accord) whilst the movement of the laptop is expressed using objective notation (because it was moved by the person).

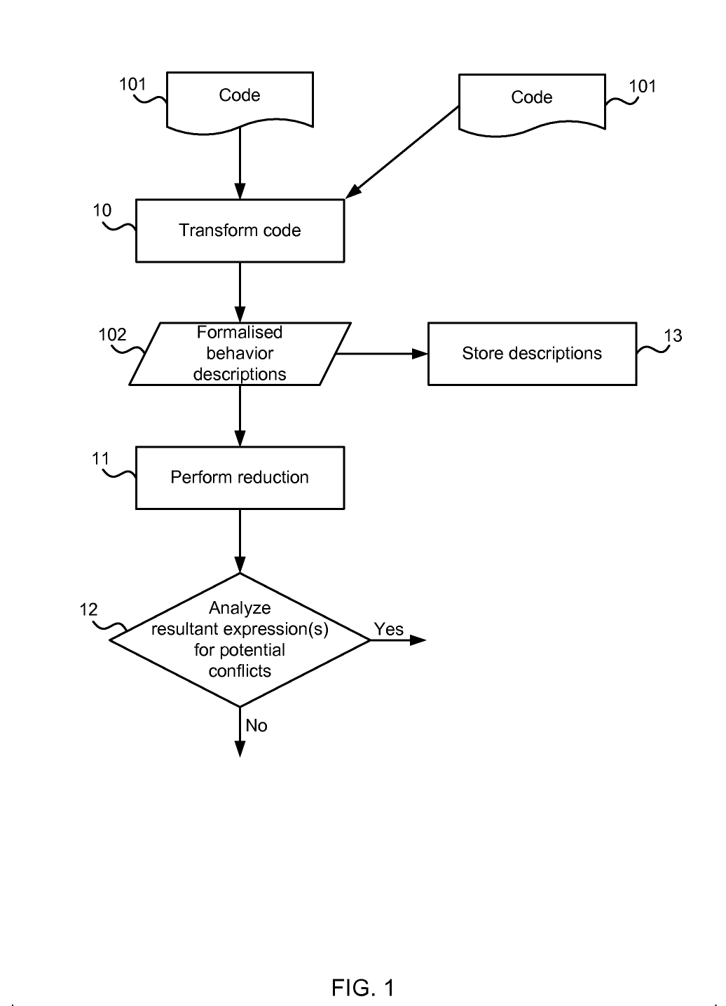

FIG. 1 is an example flow diagram of a method of predicting conflicts in a distributed system, such as a pervasive system. This method uses the ambient calculus described above, although in other examples, other process calculi (such as the π-calculus) may be used. Use of ambient calculus enables the method to deal with spatial relationships, which may not be possible if some of the other process calculi are used. Predecessors to the process calculi include ACP (Algebra of communicating Processes), CSC (Calculus of Communicating Systems) and CSP (Communicating Sequential Processes) and these may be used for some aspects of the methods. UML (Unified Modeling Language) may be used to depict a pervasive system (e.g. in a graphical representations), however, the automated reasoning about the system's structure and behavior is not possible. The automated reasoning is enabled by the reduction rules (or equivalent) given by the calculus.

According to the method shown in FIG. 1, one or more pieces of source code 101 are each transformed into a term of the process calculi (block 10). Each piece of source code may represent a different program running in the system or pieces of source code may describe human actions (as described in more detail below). These terms of the process calculi may be referred to as the formalized behavior descriptions 102 for each of the pieces of source code and these may be stored in a repository (block 13). The transformation process (block 10) may use a look-up table, or other representation of transformation rules, to determine how the source code is transformed from the programming language to the process calculus notation (as described above), and the content of the look-up table may, therefore, be dependent upon the programming language used (e.g. C#, N# etc). For example, for programming language C#, each instance of a ‘class’ is mapped to an ambient (e.g. of form a[ ]) whilst each ‘method’ is mapped to a process (e.g. P, as above). Different pieces of source code 101 may be written in different programming languages, resulting in the use of different transformation rules in the transformation process (block 10) and typically distributed systems (such as pervasive systems) are very heterogeneous. The resultant expressions 102 are all in the same notation irrespective of the programming language used for the source code.

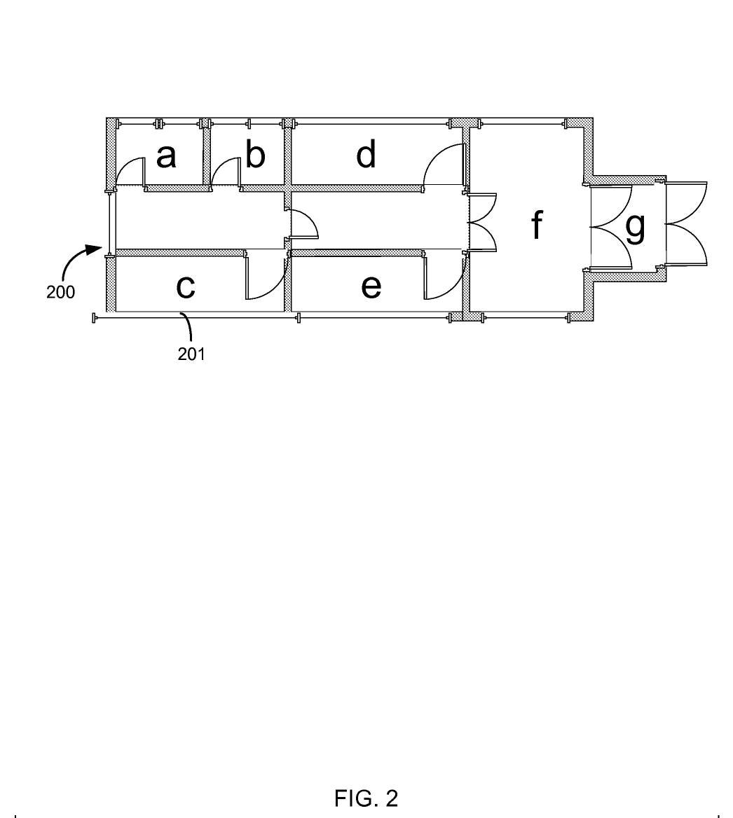

In order that the transformation process (block 10) uses common variables in each transformation, a real world scheme may be defined. For example, a building plan 200 may be labeled to identify the name of each room 201, as shown in FIG. 2. In ambient calculus, locations are represented by named ambients, and therefore if rooms a and b are offices whilst room c is a meeting room and all three rooms are within a restricted area, r, this restricted area within the building plan 200 may be expressed as:

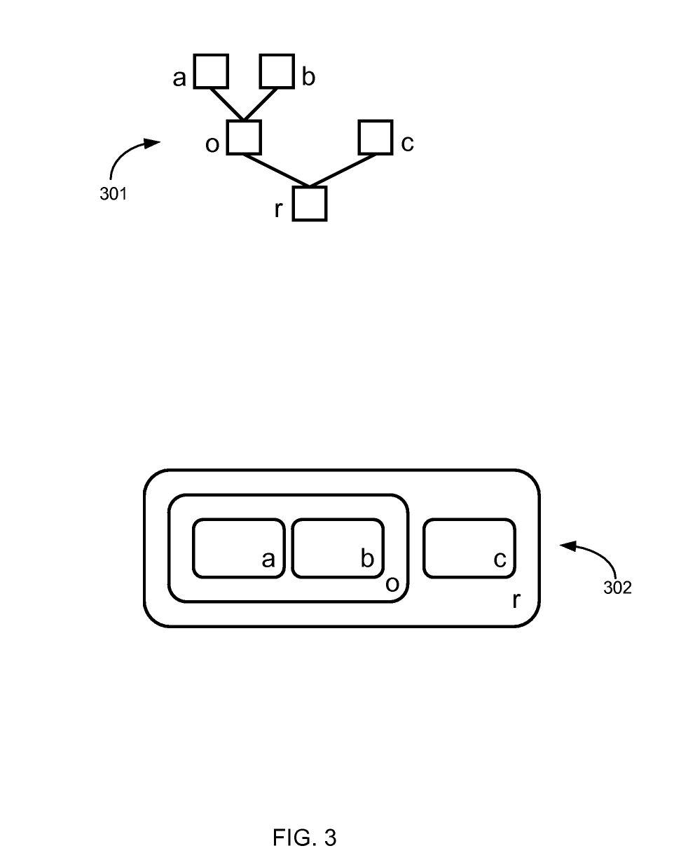

r[o[a[0]|b[0]]|c[0]]

where 0 represents the void process. This ambient example can also be represented in a tree structure 301 or alternative notation 302 as shown in FIG. 3. This expression of the defined scheme is included within the formalized behavior descriptions 102 and may also be stored in a repository (block 1 3). In order to define this scheme, a custom tool may be used which enables a user to draw a plan (e.g. as shown by plan 200 in FIG. 2) or other scheme and add symbols for other ambients (e.g. sensors, actuators, devices etc) and then the tool may automatically generate the ambient description (i.e. the expression of the scheme in ambient calculus), such as r[o[a[0]|b[0]]|c[0]] in the example of FIG. 2 described above.

The formalized behavior descriptions 102, including any generated in block 10 and any expression of the real world scheme, are then used to perform a reduction process (block 11) which takes all the terms in the process calculi, denotes them as a parallel composition of terms and then applies the reduction rules of the calculus. The parallel composition of terms has the form:

a [ . . . ]|b [ . . . ]|c[ . . . ]|d [. . . ]

where there are four pieces of source code which have been transformed and which will operate concurrently in the system. Each term may be complex and may include several simultaneously existing ambients (e.g. a[ . . . ] may be of the form a[a′[ . . . ]|a″[ . . . ]|a[ . . . ]]). The reduction rules for the ambient calculus are described in the paper by Luca Cardelli and Andrew Gordon referenced above and include:

n[in m.P|Q]|m[R]→m[n[P|Q]|R]

m[n[out m.P|Q]|R]→n[P|Q]|m[R]

open n.P|n[Q]→P|Q

mv in m. P|m[R]→m [P|R]

m[mv out m. P|R]→P|m[R]

The first three rules listed above relate to subjective moves, whilst the last two rules relate to objective moves, as indicated by the prefix ‘mv’ and described above. The expression ‘mv in m.P’ within the fourth rule (mv in m.P|m[R]→m [P|R]) means ‘move into m and then continue as P’. After the reduction, process P is running within ambient m in parallel to process R.

A simple example of the reduction process can be described for the real world scheme of FIG. 2 plus two laptops (laptop1 and laptop2). If it is known that the laptops will move into room a, the ambient program for this will be:

laptop1[in r. in o. in a. 0]

laptop2[in r. in o. in a. 0]

These expressions are combined with the expression for the building plan:

r[o[a[0]|b[0]]|c[0]]|laptop1[in r. in o. in a. 0]|laptop2[in r. in o. in a. 0]

and the reduction gives:

r[o[a[laptop1[0]|laptops2[0]]|b[0]]|c[0]]

Analysis of this reduced expression shows that both laptops end up in the same room (room a). Depending on whether this is considered to be a conflict situation (as described in more detail below), a potential conflict may, as a result, be identified. In an example, this may be considered a conflict situation if there is a projector in room a which both laptops will attempt to use to project their display.

Where, at any point in the reduction process, options arise, each of these options is separated out and each expression subject to further reduction (if possible). As a result, it is possible to determine whether the different options achieve the same end result. For example, given three options for reduction of a first term f′, f″ and two options for a second term g′, g″, the following expressions may be generated:

f′|g′

f′|g″

f″|g′

f″|g″

On further reduction, it may be determined whether there are four possible outcomes or whether some or all of the outcomes are equivalent. For example:

f′|g′→h

f′|g″→h

f″|g′→h′

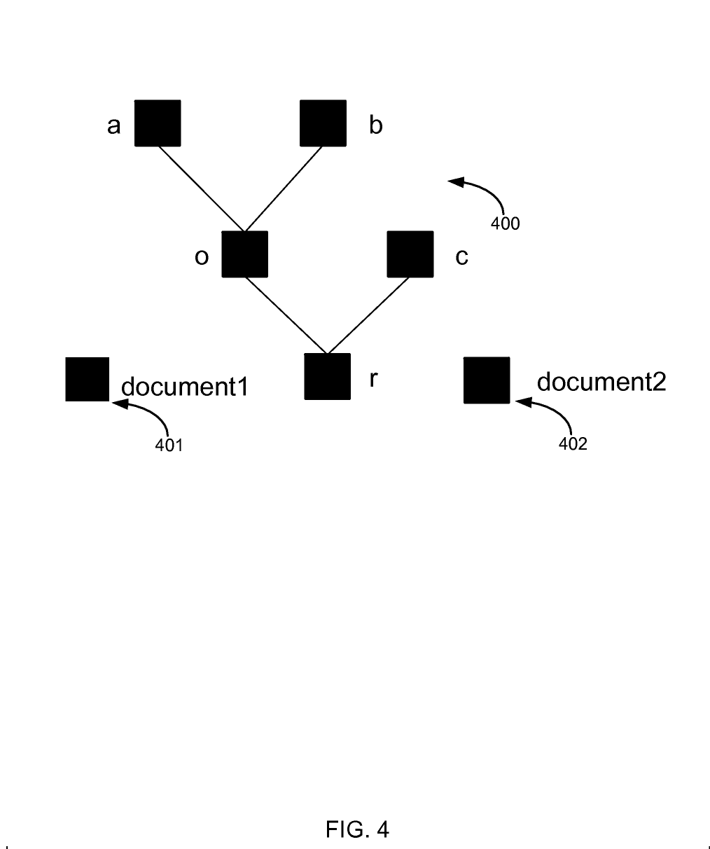

f″|g″→h′

where the four options are reduced to two possible outcomes, h, h′. An example in which options arise is described below with reference to FIGS. 4-6.

The output of the reduction process (block 11) is therefore one or more expressions. These can then be analyzed (block 12) either manually or automatically to identify any potential conflicts. The analysis may use a rule based expert system. What constitutes a potential conflict may be defined in a set of rules in combination with the real world scheme (e.g. as shown in FIG. 2) and these rules and the scheme may be processed in the expert system. The conflicts may define situations where elements conflict (e.g. two devices both trying to control a third device at the same time) and/or may define local policy (e.g. any document entering room c, which is not a locked office room, is a violation of company policy). In a simple example of the analysis, only a restricted set of potential conflicts may be identified, such as two ambients of a certain type being located within a parent ambient (e.g. two laptops located within a meeting room). In a further example of where a conflict may be predicted, a program for a presentation room may be written which includes three processes:

Process 1: output on the projector

Process 2: output on the speaker

Process 3: output on every laptop in the room

If the projector is on, the presentation is shown on the projector, if the speakers are on the sound is played, and if laptops are connected to the network, the presentation is also displayed on the participants' laptop displays. If however, one laptop comes with a process saying that during the presentation Microsoft Outlook (trade mark) is opened, a conflict will be identified: Microsoft Outlook (trade mark) open vs. presentation output on the laptop display.

A simple example of the reduction and analysis steps where options arise can be described with reference to FIGS. 4-6. FIG. 4 shows a representation of office space 400 and two documents 401, 402 referred to as document1 and document2. In this example there are three programs which be expressed in ambient calculus as:

r[o[a[0]|b[open document1. 0|pen document2. 0]|c[0]]

document1[in r. in o. in a. 0|in r. in o. in b. 0]

document2[in r. in c. 0|in r. in o. in b.0]

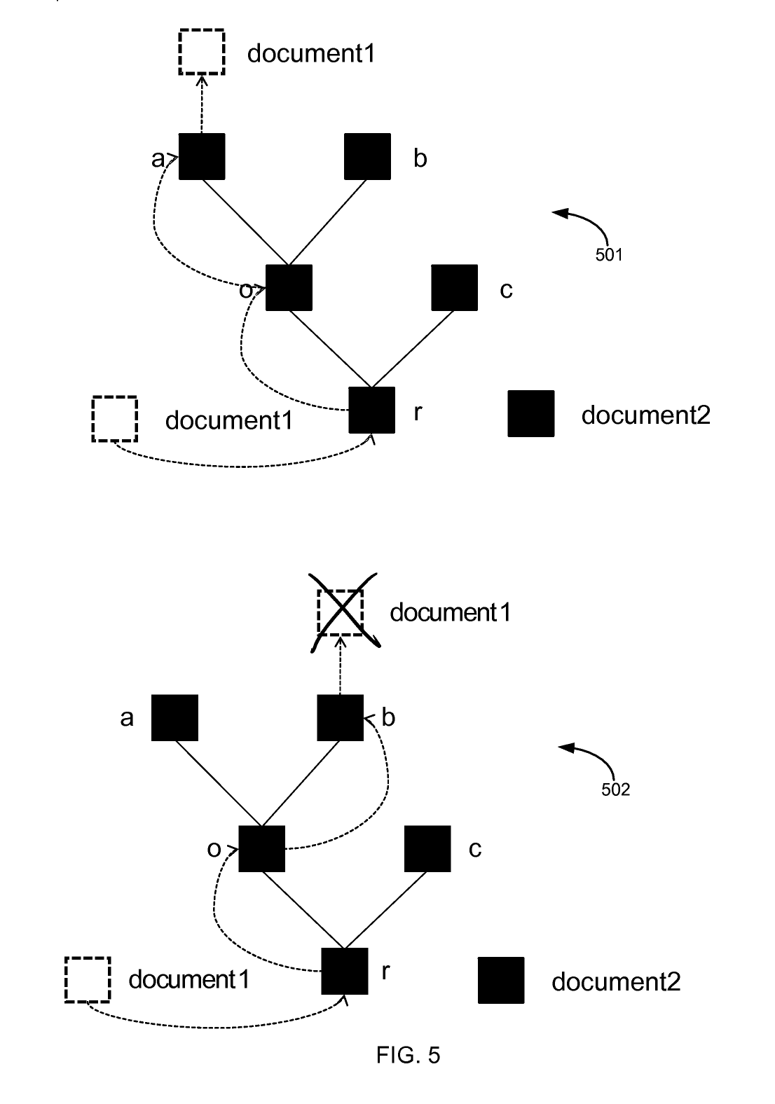

The example may be considered in two steps (steps a and b) which happen at the same time. In a first step, step a, the execution of the first two expressions is considered.
As a result two possible situations arise, as shown in FIG. 5:

(I) document1 moves into room a (document1 [in r. in o. in a. 0]) and stays there, 501 or

(II) document1 moves into room b (document1 [in r. in o. in b. 0]) and is deleted there (b[open document1. 0], 502.

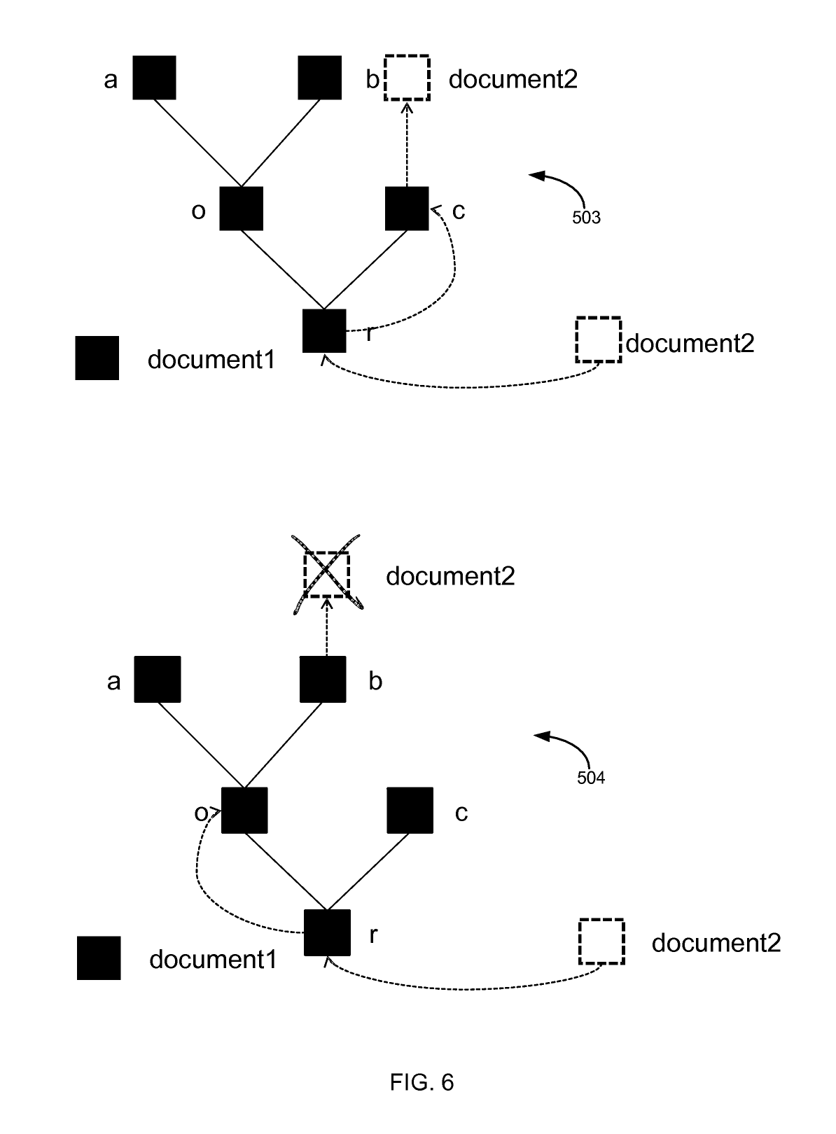

In a second step, step b, the execution of the first and third is considered.
As a result two further possible situations arise, as shown in FIG. 6:

(III) document2 moves into room c (document2[in r. in c. 0]) and stays there, 503 or

(IV) document2 moves into room b (document2[in r. in o. in b.0]) and is deleted there (b[open document2. 0], 504.

After applying the reduction to each of the combinations of options for each of the documents (in analogous manner to f′|g′, f′|g″, f″|g′, f″|g″ described above), there are several possibilities:

| | |
|---|---|
| (I) + (III) | r [o[a[document1[0]]\|b[0]]\|c[document2[0]]] |
| | (Both documents remain) |
| (I) + IV) | r[o[a[document1[0]]\|b[0]]\|c[0]]] |
| | (Only document1 is left) |
| (II) + (III) | r[o[a[0]\|b[0]]\|c[document2[0]] |
| | (Only document2 is left) |
| (II) + (IV) | r[o[a[0]\|b[0]]\|c[0]] |
| | (Both documents gone) |

By analyzing these outcomes, it can be predicted that the initial state (of no documents in any of the rooms) does not differ if only (II), or only (IV) or (II) with (IV) happen.

By applying the reduction rules for the process calculus being used and the subsequent analysis, (e.g. the Ambient Calculus), the following actions will be detected:
Movements of programs (e.g. agents) amongst host systems
Movement of hardware (e.g. autonomous devices), entering the interaction range of other devices (e.g. entering another room), driven by the programs
Communication among the programs including traces of these messages
Requesting resources from other programs
   For example, the execution of laptop[in r.0|in c.0|in b.0] with the scheme of FIG. 2 will show that the laptop never moves into room b. The laptop will move in to r and then into c once within r; the directive ‘in b.0’ will never be executed.

As described above, each of the source code elements 101 may be written in the same or different programming languages. Some elements may be written in the programming language N#, as described in the paper ‘Towards a Programming Paradigm for Pervasive Applications based on the Ambient Calculus’ by Weis, Becker and Brändle and published in the International Workshop on Combining Theory and Systems Building in Pervasive Computing (CTSB) at Pervasive 2006. N# is a programming language for pervasive applications which uses the concepts of the ambient calculus and therefore may be suited to use with the methods described herein. The transformation rules for N# are straightforward because the language includes the concept of an ambient and a process running inside an ambient and therefore ‘ambient’ is mapped to an ambient (e.g. of form a[ ]) whilst ‘process’ is mapped to a process (e.g. P, as above).

In addition to performing the reduction (in block 11) on a collection of formalized behavior descriptions 102 created by transforming code 101 (in block 10), the formalized behavior descriptions 102 may also include expressions which describe human interactions (e.g. moving of a laptop from one room to another). These expressions may be written directly in the ambient calculus or may be written in a programming language (such as N#) and then transformed (in block 10) as described above. Inclusion of the descriptions for human interaction enables conflicts to be predicted which result from potential human actions and therefore such actions can be prevented or conflicts resolved.

In a further example, the reduction (in block 11) may be performed on a combination of two or more of the following:
A term in the process calculus created from source code by the transformation process (block 10), either immediately prior to the reduction or previously
A term in the process calculus which has been written directly in that form (e.g. which describes a human interaction)
A term in the process calculus which is provided by a third party (e.g. it may have been created from source code using the transformation process of block 10 by the third party but the source code may not be available at the time the reduction is performed)
   This enables software developers to make available terms in the process calculus to those analyzing the system without requiring them to make available the source code itself.

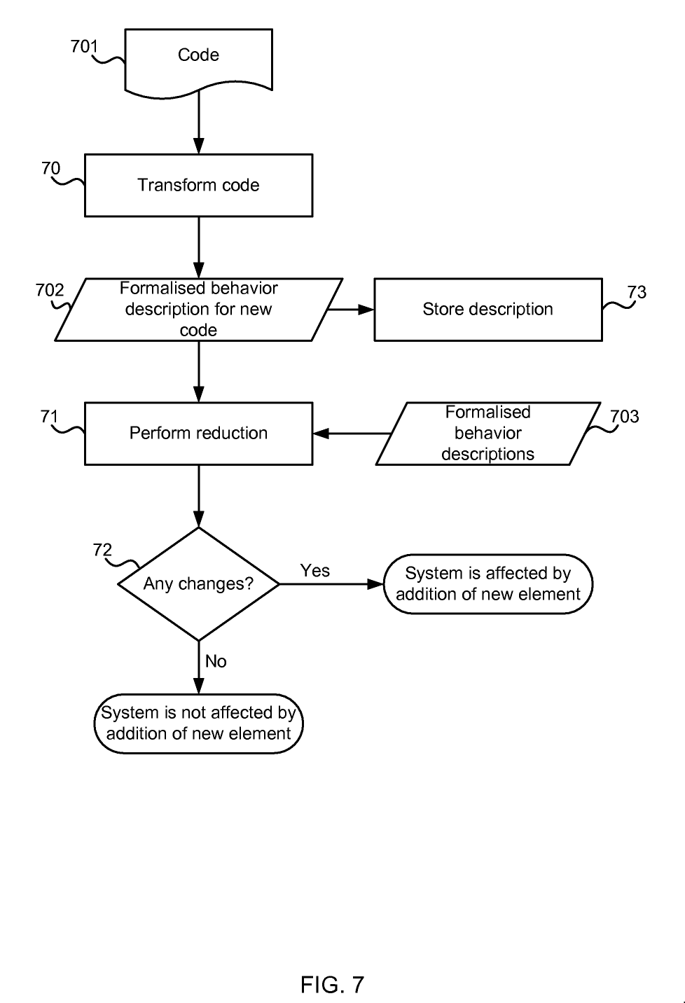

FIG. 7 is a second example flow diagram of a method of predicting conflicts in a distributed system, such as a pervasive system. This method may be used to analyze the effects of adding a new source code element to an existing system. The existing system may have previously been analyzed (as described above with reference to FIG. 1) or may first be analyzed (e.g. using the method of FIG. 1) to provide a comparison with the results (obtained using the method of FIG. 7) once the new source code element is introduced.

The new source code element 701 is transformed (block 70) using transformation rules, a look-up table or other suitable method into a formalized behavior description in the process calculus 702. Reduction is then performed (block 71) on this expression combined with the formalized behavior descriptions for the existing elements in the system 703 (i.e. in the form of a parallel composition of the new expression and the existing formalized behavior descriptions). These formalized behavior descriptions 703 for existing elements may be accessed from a repository (not shown in FIG. 7). The resultant reduced expression (output from block 71) can then be compared manually or automatically (in block 72) to the resultant reduced expression for the existing system (e.g. the output from block 11, which may also have been stored in a repository or which may be recalculated within block 71 from the existing formalized behavior descriptions 703 without the formalized behavior description for the new code 702). If differences are identified (‘Yes’ in block 72), this indicates that the introduction of the source code element will affect the existing system and further analysis may be required to determine whether conflicts are predicted (in a similar manner to in block 1 2), however if no differences are identified (‘No’ in block 72), this indicates that the introduction of the new source code element will have no effect on the existing system (and therefore any previous checking for predicted conflicts is still valid). The formalized behavior description 702 generated for the new source code element (in block 70) may be stored (block 73) in a repository. The resultant reduced expression (output from block 71) may also be stored in a repository (not shown in FIG. 7).

In a simple example, there may be two elements of source code in an existing system and these may have the following formalized behavior descriptions 1 02:

a[ ]

b[in a.P]

These may be reduced (in block 11) to the following expression:

a[ ]|b[in a.P]→a[b[P]]

If a new source code element 701 is added which has a formalized behavior description 702 (generated in block 70) of:

r[in a. open r.0]

When the reduction is performed (in block 71) the resultant expressions are:

a[ ]|b[in a.P]→a[b[P]] (i)

a[ ]|b[in a.P]|r[in a. open r.0]→a[b[P]|r[open r. 0]]→a[b[P]] (ii)

where the first expression (i) relates to the existing system and the second expression (ii) relates to the existing system with the additional code. As the resultant expressions are the same, no changes are detected (in block 72).

The method of FIG. 7 may also be used to analyze the effects of adding a new human interaction with an existing system. In this case, the human action may be written directly in the ambient calculus (in which case this is provided as an input to block 71 and block 70 does not occur) or may be written in a programming language (in which case the method operates as shown in FIG. 7, with the code being transformed into the ambient calculus in block 70). The objective moves (prefixed with ‘mv’, as described above) may be often used in expressions for human interaction where a person moves a device (e.g. a laptop computer).

A simple example can be described with reference to the real world scheme shown in FIG. 2, which shows a building plan including office space (a and b, and c) and meeting venues with public access (d, e, f, and g). This structure can be expressed in the calculus as:

a[0]|b[0]|c[0]|d[0]|e[0]|f[0]g|[0]

In order to distinguish between public and restricted areas, two additional areas ‘pub’ and ‘res’ can be added, such that the expression is now:

res[a[0]|b[0]|c[0]]|pub[d[0]|e[0]|f[0]|g[0]]

Additionally, both areas may be placed within an ambient ‘bid’ representing the building itself:

bld[res[a[0]|b[0]|c[0]]|pub[d[0]|e[0]|f[0]|g[0]]]

If the new action which is to be considered (according to the method of FIG. 7) is the moving of a meeting from room d to room e, ambients are created for the public meeting rooms d and e, with P and Q being processes running within these rooms, e.g. the empty process 0. Furthermore a subambient m may be created for a meeting taking place in room d, (where a subambient is an ambient which is within a parent ambient). Applying the primitives of Mobile Ambients, a program to move the meeting m from room d into room e can now be written. After the meeting is closed the open primitive is then applied to ambient m to terminate the meeting ambient. The resulting expression in the ambient calculus is:

d[P|m[out d. in e. R]]|e[Q|open m]

This can be subject to reduction as follows:

d[P|m[out d. in e. R]]|e[Q|open m]

→* d[P]e[|Q|m[R]|open m]

→d[P]|e[Q|R]

In an example, the process Q running all the time in the meeting room may be the environmental controlling such as lights, shades, microphone etc, whilst the process R may be a process causing the environmental control to shut down. Since the process R is released only after the meeting ambient m was dissolved, the environment control can only be shut down once the meeting has finished. It was not possible before as the process R was encapsulated in the meeting ambient. The analysis determines that Q and R interfere only after the meeting ambient was opened.

The unreduced expression may be combined in a parallel composition with formalized behavior descriptions for other processes already operating within meeting rooms d and e and then reduction performed (in block 71) to see whether any changes are identified. For example, if there is another process left in e, after m is opened e.g. e[Q|R|S] and it is known that R will shut down Q, it can be identified that there is a potential problem because S is left in that room ambient and after shutting down Q no process should be left running in the room.

It will be appreciated that the above example provided a detailed look at rooms d and e, rather than considering the surrounding ambient. As a result, the reduction considered only a section of the overall program rather than the whole expression. This whole expression would be:

bld[res[a[0]|b[0]|c[0]]pub[d[P|m[out d. in e. R]]|e[Q|open m|f[0]|g[0]]]->*bld[res[a[0]|b[0]|c[0]]|pub[d[P]|e[Q|R]|f[0]|g[0]]]

In situations where detailed analysis of a part of scheme is required, performing reduction on a section of the overall program may be simpler.

As the method of FIG. 7 uses the formalized behavior descriptions 703 for the existing pervasive system, it is not necessary to have access to the source code in order to analyze whether the addition of the new element (e.g. new source code element 701) will affect the system.

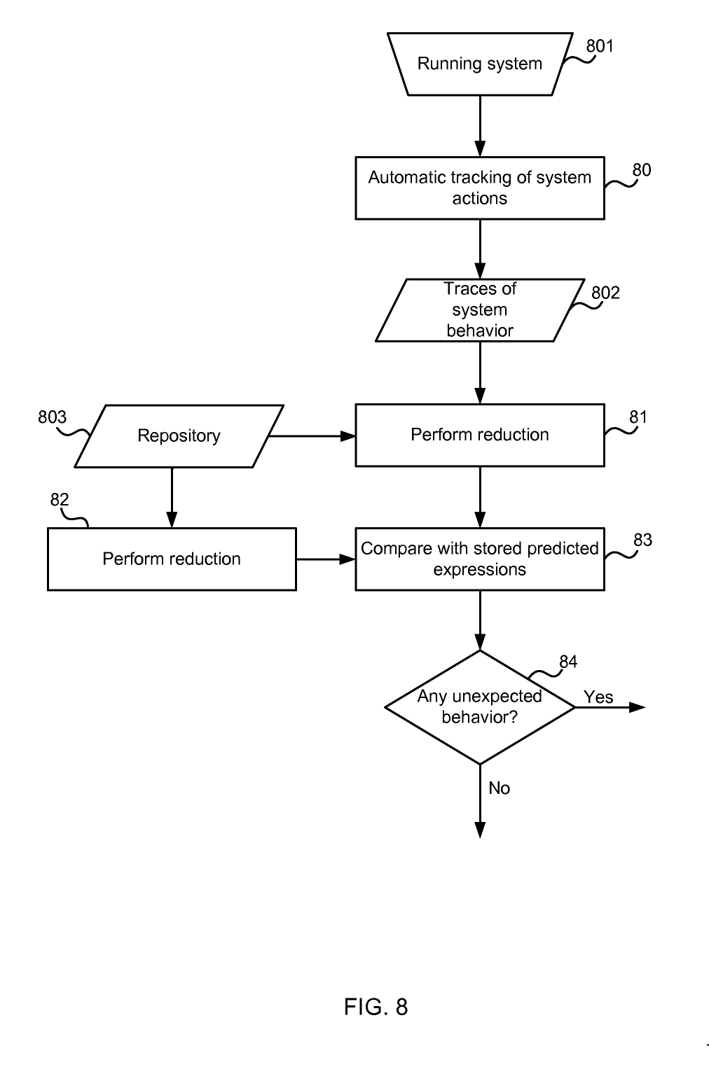

Whilst the methods shown in FIGS. 1 and 7 and described above can be operated prior to compile time (and therefore prior to system deployment), the techniques may also be applied to a running system in order to determine the origins of any errors and conflicts that occur, and this method is shown in the example flow diagram of FIG. 8. According to the method, a running system 801 is monitored and the actions of the system are automatically tracked (block 80). The tracked actions may include the four different actions which are described above (in relation to the detected actions in the reduction process). Expressions in the process calculus 802 are generated for the traces (within block 80). These expressions for the traces 802 are reduced (block 81) using the reduction rules for the process calculus (in a similar manner to that described above with reference to blocks 11 and 71). The reduced expressions are then compared (block 83) with the reduced expressions from the analysis of the system without the traces (generated in block 82), which uses formalized behavior descriptions which may be accessed from a repository 803 (in which they were stored in block 13 or 73) and any unexpected behavior identified (block 84). Alternatively, the comparison (in block 83) may be performed against stored reduced expressions from pre-runtime analysis of the system which may be accessed from the repository 803 (and block 82 does not occur).

The traces may be generated by monitoring the movements of devices programs/people (e.g. when did a person enter/leave a room building indicated by the security card swiped on the door). A monitor program may be used to track movements of devices or sensor data, whilst devices and programs may report their changes back to a central server which can then process the information (e.g. generate the traces).

In a simple example, the pre-runtime analysis or the reduction in block 82 identifies certain states which may be reached at the end, e.g. h and h′. If the traces are included, the reduction (in block 81) may result in either the end states h and h′, indicating that the traces and the original program were identical or may result in something completely different (neither h nor h′), indicating that something happened in the system which was not expected.

In another simple example, which follows from the example shown in FIGS. 4-6 and described above, the earlier analysis identifies that a document is only erased if it ends up in room b. However, if a trace shows that document2 ended up in room c and was erased there (the trace includes ‘open. 0’), addition of this trace to the already known program (e.g. the expressions for steps a and b) will lead to different possible end situations (i.e. unexpected behavior identified in block 84).

If unexpected behavior is identified (in block 84), the origin of the conflict may be determined by looking at actions that are already described in the repository and/or tracking additional actions not already in the repository. Where actions are already described in the repository (e.g. move meeting from one room to another room), the original action in the parallel composition can be replaced by the corresponding trace and the reduction rules applied (in a corresponding manner to block 81). The results are compared to the predicted expressions (in a similar manner to block 83) to determine whether that trace has the same effect as the original program (i.e. if the same results are obtained). To track additional actions (e.g. another person entered the room, removed a document from the meeting for making copies and brought back the document), one or more of these traces can be added to the original formalized descriptions and the reduction performed to determine if they cause unexpected behavior. By repeating such analysis (e.g. looking at the effects of different traces or combinations of traces), the cause of the unexpected behavior (which may be a single trace or a combination of traces) can be identified.

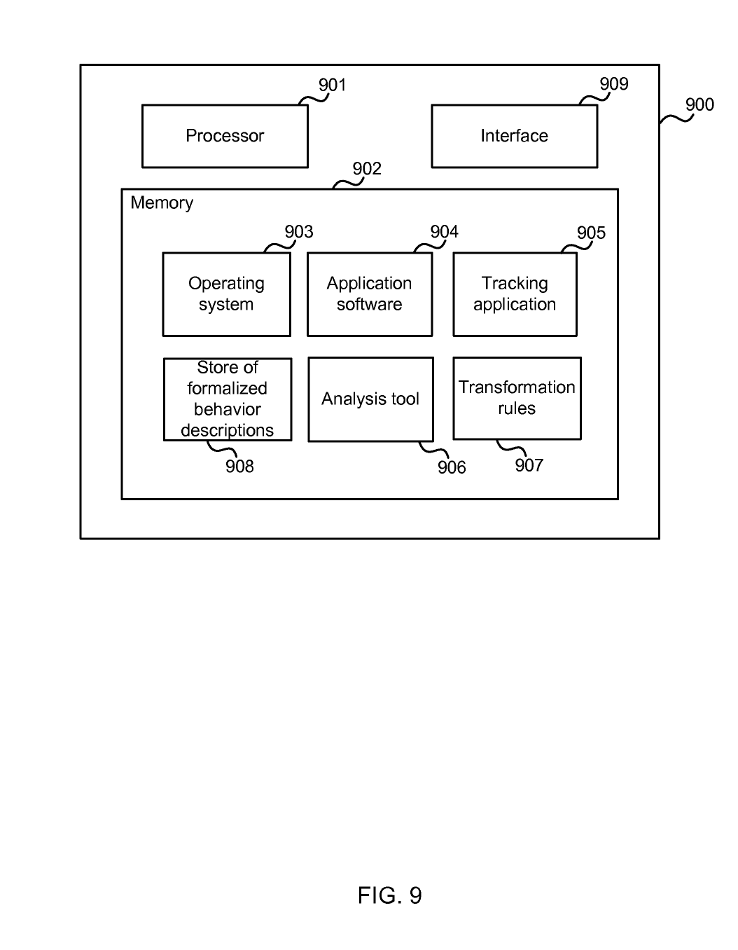

FIG. 9 illustrates various components of an exemplary computing-based device 900 which may be implemented as any form of a computing and/or electronic device, and in which embodiments of the methods described above may be implemented.

Computing-based device 900 may comprise one or more processors 901 which may be microprocessors, controllers or any other suitable type of processors for processing computing executable instructions to control the operation of the device in order to perform any aspects of any of the methods described above.

The computer executable instructions may be provided using any computer-readable media, such as memory 902. The memory may be of any suitable type such as random access memory (RAM), a disk storage device of any type such as a magnetic or optical storage device, a hard disk drive, or a CD, DVD or other disc drive. Flash memory, EPROM or EEPROM may also be used.

Platform software comprising an operating system 903 or any other suitable platform software may be provided at the computing-based device, e.g. in memory 902, to enable application software 904 (which also may be stored in memory 902) to be executed on the device. The application software may, in some examples, include a tracking application 905 (for tracking of system actions, as in block 80 of FIG. 8) and/or an analysis tool 906 (for performing analysis such as comparisons, e.g. such as in blocks 12, 72 and 84). The memory 902 may further comprise the transformation rules 907 (e.g. in the form of look-up tables or other mapping data used in transforming code from source code to an expression in a process calculus) which may, for example, be used in blocks 1 0 and 70. The memory may further comprise a store for the formalized behavior descriptions 908 (as described above).

The computing-based device may further comprises one or more inputs which are of any suitable type for receiving media content, Internet Protocol (IP) input and one or more interfaces 909. The interface(s) may comprise a communication interface, an interface for a user input device etc.

A number of outputs may also be provided (not shown in FIG. 9) such as an audio and/or video output to a display system integral with or in communication with the computing-based device. The display system may, in some examples, provide a graphical user interface, or other user interface of any suitable type.

Whilst the above description refers to using a parallel composition of terms to combine the formalized behavior descriptions, in some examples the terms may be combined in an alternative way. For example, techniques may be used which support the sequential concatenation of processes.

Whilst the above description refers to the use of Mobile Ambient Calculus, this one example of a suitable process calculus. In other examples, alternative calculi may be used, such as the π-calculus, predecessors to the process calculi (as described above) or variants of any of these (e.g. variants of the ambient calculus or π-calculus). Examples of variants of the ambient calculus include ‘Boxed Ambients’, ‘Secure Ambients’, ‘Safe Ambients’ and ‘Channel Ambient System’ developed by Andrew Phillips at Microsoft Research.

The methods described above may be used in many different applications and may be used to predict conflicts in many different types of systems, including distributed and parallel (or concurrent) systems. Pervasive systems are an example of a distributed system. The term ‘pervasive system’ is used herein to refer to any system in which many independent processes (e.g. programs) are running in parallel and where the technology is not obvious to the user. Pervasive systems (also referred to as ubiquitous systems) have been described in ‘The Computer for the 21st Century’ by Mark Weiser, published in Scientific American Special Issue on Communications, Computers, and Networks, September, 1991 and reprinted in ACM SIGMOBILE Mobile Computing and Communications Review, vol. 3, pp. 3-11, July 1999. In a further example, the methods described above may be used in modeling of biological systems, where the cells may be considered as parallel running ambients with processes running within the cells. A biological system can be considered as a distributed or parallel system on a high abstraction level.

Although the present examples are described and illustrated herein as being implemented in a computing device as shown in FIG. 9, the system described is provided as an example and not a limitation. As those skilled in the art will appreciate, the present examples are suitable for application in a variety of different types of computing systems.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. It will further be understood that reference to ‘an’ item refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples /embodiments/methods described above may be combined with aspects of any of the other examples/embodiments/methods described to form further examples/embodiments/methods without losing the effect sought.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method of analyzing programs in a system comprising:
transforming a piece of source code relating to the system into an expression in a process calculus; and
applying reduction rules for the process calculus to a parallel composition of the expression and at least one other expression in the process calculus.

2. A method according to claim 1, wherein the system is a distributed system.

3. A method according to claim 1, wherein the piece of source code relating to the system comprises a program running in the system.

4. A method according to claim 1, wherein the at least one other expression comprises a second expression in the process calculus and wherein the method further comprises:
transforming a second piece of source code relating to the system into the second expression.

5. A method according to claim 1, wherein the at least one other expression in the process calculus comprises an expression describing a human interaction with the system.

6. A method according to claim 1, further comprising:
analyzing an output from applying the reduction rules to identify potential conflicts.

7. A method according to claim 6, further comprising:
storing the output.

8. A method according to claim 1, further comprising:
storing the expression.

9. A method according to claim 1, wherein the piece of source code is written in a programming language and wherein transforming a piece of source code relating to the system into an expression in a process calculus comprises:
transforming a piece of source code relating to the system into an expression in a process calculus using transformation rules for said programming language.

10. A method according to claim 9, wherein said programming language is N#.

11. A method according to claim 1, wherein the process calculus is mobile ambient calculus.

12. A method according to claim 1, wherein applying reduction rules for the process calculus to the expression and at least one other expression in the process calculus comprises:
accessing at least a second expression in the process calculus; and
applying reduction rules for the process calculus to a parallel composition of the expression and said at least a second expression.

13. A method according to claim 12, wherein said at least a second expression comprises at least a second and a third expression in the process calculus and wherein said second expression describes a scheme within the system.

14. A method according to claim 12, further comprising:
comparing an output from applying the reduction rules with a stored output from applying reduction rules for the process calculus to said at least a second expression.

15. A method according to claim 1, further comprising:
storing an output of the step of applying reduction rules for the process calculus to a parallel composition of the expression and at least one other expression in the process calculus;
tracking a plurality of actions in a running system to produce a plurality of traces in the process calculus;
applying the reduction rules for the process calculus to a parallel composition of the plurality of traces; and
comparing the stored output and an output of the step of applying the reduction rules for the process calculus to a parallel composition of the plurality of traces (83).

16. A method of analyzing a system comprising:
accessing a term in a process calculus for each of a plurality of programs in the system;
combining each of the terms into a combined expression; and
reducing the combined expression according to reduction rules for the process calculus.

17. A method according to claim 16, wherein accessing a term in a process calculus for each of a plurality of programs in the system comprises:
converting each of said plurality of programs into a term in the process calculus.

18. A method of analyzing a system comprising:
applying transformation rules to elements of source code within the system to convert each element into a term in a process calculus; and
applying reduction rules for the process calculus to a parallel composition of at least two of the terms.

19. A method according to claim 18 wherein applying transformation rules to elements of source code within the system to convert each element into a term in a process calculus comprises:
for each element of source code, selecting transformation rules dependent on a programming language in which said element is written; and
applying the selected transformation rules to the element to convert the element into the term in the process calculus.
